(19) United States
(12) Patent Application Publication
(10) Pub. No.: US 2008/0220144 A1
(43) Pub. Date: Sep. 11, 2008

(54) FLAVORED TACO SHELLS

(76) Inventor: ANTHONY W. RICHARDS, Poplar, WI (US)

Correspondence Address: GENERAL MILLS, INC., P.O. BOX 1113, MINNEAPOLIS, MN, 55440, US

(21) Appl. No.: 12/044,520

(22) Filed: Mar. 7, 2008

Related U.S. Application Data
(60) Provisional application No. 60/893,402, filed on Mar. 7, 2007.

(51) Int. Cl. A23L 1/10

(52) U.S. Cl. 426/622

(57) ABSTRACT

A flavored corn tortilla taco shell is provided. The flavored corn tortilla taco shell has a first sidewall element, a second sidewall element, a substantially flat base element of defined width, a first curved element interconnecting the first sidewall element to the flat base element; and a second curved element interconnecting the second sidewall element to the flat base element. Methods of fabrication are disclosed.

### CROSS-REFERENCE TO RELATED APPLICATIONS

This application claims the benefit of priority under 35 U.S.C. 119(e)(1) of a provisional patent application Ser. No. 60/893,402, filed Mar. 7, 2007, which is incorporated herein by reference in its entity.

### FIELD OF THE INVENTION

The present invention relates to edible food shells and to masa dough compositions useful as a intermediate product in their preparation. More specifically, the present invention relates to flavored taco shells and to their methods of preparation.

### BACKGROUND OF THE INVENTION

This patent application describes an improvement to taco shells including self standing taco shells to provide flavored taco shells prepared from a flavored masa dough. Taco shells made from corn are commonly available in the traditional U-shaped design and have a mild corn flavor. More recently taco shells have evolved to include improved versions that are self standing as described in patent application PCT/US02/36474 Square Bottom Taco Shell, Kovich et al., and U.S. Pat. No. 5,993,871 Stable Self Supporting Taco Shell, Beehler. Self standing taco shells, unlike U-shaped taco shells, rely upon their unique shape to stand freely without the assistance of a secondary holding device or human intervention. The shape of self standing tacos is created by molding and frying tortilla shells into any of the known self standing shape designs see PCT/US02/36474 or '871. The shape of self standing tacos was purposely designed to be useful for filling standing shells with such items as cooked meat or poultry, cheese, sour cream, lettuce, tomatoes, black olives, taco sauce etc. prior to consumption. Since self standing taco shells are free standing and quite stable, a consumer can fill and eat a self standing taco rather easily without undue fear of a filled shell falling over and making a mess.

Consumer acceptance of self standing taco shells has been appreciably high. To capitalize upon the success of self standing taco shells and to continue to increase consumer interest and demand for taco shells it is desirable to now flavor taco shells. The addition of new flavor varieties to existing products in this manner is a common and highly successful marketing strategy known as creating line extensions. Of course, topically flavored fried snack products fabricated from fried masa dough pieces are well known as well as other fried snack products. These products are typically consumed without eating utensils and thus are colloquially referred to as “finger foods”. Typically, an unflavored base is prepared from an unflavored masa dough that is formed into pieces and deep fat fried. While still warm, a topical seasoning or flavor coating can be applied typically comprising a dry blend of salt and various seasoning dry powders such as dried cheese solids. While useful, the topical application of dry seasoning flavors results in a product that often undesirably results in products that transfer residual amounts of the dry powder topical seasoning blend from the finger food to the consumer's fingers resulting in an undesirable untidiness. Also, food products prepared from flavored dough formulations that do not include a topical seasoning are well known. However, while incorporating flavors into traditional U-shaped taco shells and more preferably self standing taco shells is highly desired there are significant challenges to manufacturing, packaging and consumer acceptance of flavored taco shells.

Commonly taco shells are made by deep-fat frying white or yellow corn tortillas held in a mold. Corn tortillas are made from masa dough. One generally accepted way to make masa dough is to heat dried corn kernels in a slightly corrosive solution of water and lime. This process assists in removal of the kernel's tough outer skin. Once the skins are removed, kernels can be rinsed and boiled in fresh water, drained and mashed into masa dough. Small portions of masa dough are flattened into the desired diameter and thickness for tortillas and cooked very quickly often on each side on a hot flat surface. Creating masa dough of the correct consistency is an essential step in the creation of corn tortillas. Adding flavor ingredients to masa dough prior to forming flavored tortillas and subsequent molding and frying flavored tortillas into flavored taco shells significantly impairs the manufacturing process and yields a high number of unacceptable shells characterized in part by an unacceptably narrow gap between the sides of the shell. This problem is apparent upon removal of hot flavored corn tortilla taco shells from the fryer. Hot flavored corn tortilla taco shells are plastic and pliable upon removal from the fryer. Gravity immediately acts upon hot shells causing a predictable collapse in the overall structure of the self standing taco shell not exhibited with unflavored masa dough. One theory as to the cause of this problem is that flavor ingredients disrupt the natural cohesive structure of prepared masa dough creating a softer less cohesive dough. This problem can also be a localized phenomenon whereby the opening of flavored self standing taco shells closes appreciably due to a convergence of the opposed sidewalls.

Collapsed or closed U-shaped and self standing taco shells are difficult to handle and nearly impossible to stack and package. Consumers find collapsed or closed traditional U-shaped and self standing taco shells undesirable because they are difficult to fill and they hold less taco filling. Additionally, in a collapsed or closed state self standing taco shells often will not function as self standing food items.

Flavoring large flour tortilla shells gained great popularity as wrap sandwiches dominated the food service landscape in the late 90's and beyond. However, wheat flour tortillas differ greatly from corn masa tortillas. Wheat flour tortillas have a unique capacity for accepting ground garden vegetable and juice additives. Due in large part to the nature of wheat flour dough, the process of adding ground garden vegetable and juice additives to wheat flour tortillas is no more difficult to someone skilled in the art than flavoring traditional loaf bread. In stark contrast, corn masa dough does not readily accept any additives especially ground garden vegetable and juice additives without severe detrimental impact upon the performance of the dough.

There is a need in the art for flavored corn taco shells that are not undesirably collapsed or closed and that are easy to stack and package. Likewise, there is a need in the art for flavored corn taco shells that have an opening of sufficient size to fill such a taco shell with taco fillings in traditional and self standing versions.

### BRIEF SUMMARY OF THE INVENTION

In its product aspect one embodiment of the present invention is flavored corn masa dough. The flavored masa dough product comprises corn masa flour, water, seasoning blend, salt and optionally added fat. The flavored masa dough product can also optionally contain ground deep-fat fried flavored or unflavored corn tortillas (regrinds). The flavored masa dough product can also optionally contain minor portions of other cereal grain ingredients. The flavored masa dough product can also optionally contain minor amounts of natural or artificial color and preservatives.

In another product aspect of the present invention is a flavored corn tortilla fabricated from flavored corn masa dough. The flavored corn tortilla comprises flavored corn masa dough flattened into a round tortilla of desired diameter and thickness cooked by applying heat to both sides until a desired moisture content and doneness is achieved. Desired doneness can include partially cooked to fully cooked flavored corn tortillas. Depending on the final application, uncooked flavored tortillas are also desirable.

In another product aspect the present invention is a flavored corn masa taco intermediate fabricated from a flavored corn masa tortilla shaped by a mold. The flavored taco shell intermediate comprises a flavored corn masa dough tortilla of desired diameter and thickness shaped by a mold. The flavored taco intermediate is configured so the lip distance of the taco intermediate is approximately 25% to 30% larger than the desired lip distance of cooled deep-fat fried flavored taco shells. Additionally, flavored taco shell intermediates of flavored self-standing taco shells are configured with a lip distance 2.5 to 3 times the width of the base prior to deep-fat frying.

In still another product aspect the present invention is a hot (about 150-180° C.) deep-fat fried, flavored corn tortilla taco shell fabricated from flavored corn masa taco intermediates. The hot deep-fat fried, flavored corn tortilla taco shells comprise flavored corn taco intermediates deep-fat fried in hot cooking oil until a desired shape, moisture, residual oil content and doneness are achieved. The hot deep-fat fried, flavored corn tortilla taco shell is configured so the lip distance of the hot flavored taco shell is approximately 25% to 30% larger than the desired lip distance of cooled deep-fried flavored taco shells. Hot deep-fat fried, flavored corn taco shells have a plastic pliable texture. Additionally, hot deep-fat fried flavored self standing corn taco shells are configured with a lip distance 2.5 to 3 times the width of the base prior to cooling.

In still another product aspect the present invention is a cooled or room temperature deep-fat fried flavored corn tortilla taco shell obtained from hot deep-fat fried flavored corn tortilla taco shells. The cooled deep-fat fried, flavored corn tortilla taco shells comprise flavored corn masa taco intermediates deep-fat fried in hot cooking oil until a desired shape, moisture, residual oil content and doneness are achieved and subsequently cooled: The cooled deep-fat fried flavored corn tortilla taco shell is configured so that the lip distance of the cooled flavored taco shell is approximately 25% to 30% smaller than the lip distance of flavored taco shell intermediates and hot deep-fat fried flavored corn taco shells. Cooled deep-fat fried flavored corn taco shells have a solid crispy or frangible texture. Additionally, cooled deep-fat fried flavored self standing corn taco shells are configured with a lip distance 1.8 to 2.2 times the width of the base.

In the preferred embodiment the cooled deep-fat fried, flavored corn tortilla taco shells are stable, self-standing, flavored taco shells with a first sidewall and a second sidewall interconnected by a substantially flat base. The cooled deep-fat fried, flavored self standing taco shell is configured so the height of the taco shell is approximately 1.50 to 4.0 times the width of the base.

In another embodiment, the cooled deep-fat fried flavored self-standing, taco shell has a first sidewall and a second sidewall interconnected by a substantially flat base. The cooled deep-fat fried flavored taco shell is configured so that the height of the cooled deep-fat fried flavored taco shell is approximately about 50-110 millimeters and the width of the base is at least 10-15 millimeters. In another embodiment, the width of the base is at least 19 millimeters. In yet another embodiment, the width of the base is approximately 25 millimeters.

In another embodiment, the cooled deep-fat fried flavored self-standing, taco shell has a first sidewall element, a second sidewall element and a substantially flat base element. The flat base element comprises a first curved segment interconnecting the first sidewall element to a flat base segment, and a second curved segment interconnecting the second sidewall element to the flat base segment. In one embodiment of this flavored taco shell, at least one of the elements will have a thickness of at least 1.5 millimeters. In one embodiment of this flavored taco shell, at least one of the elements will have a thickness of less than 1.5 millimeters. In other embodiments of this flavored taco shell, the curved segments may have large, medium or small radii.

In another embodiment, the cooled deep-fat fried flavored self-standing, taco shell has a first sidewall element, a second sidewall element and W-shaped base element. The W-shaped base element comprises a first curvilinear segment interconnecting the first sidewall element to an inversed curvilinear segment, and a second curvilinear segment interconnecting the second sidewall element to the inverse curvilinear segment. In one embodiment of this flavored taco shell, at least one of the elements will have a thickness of at least 1.5 millimeters. In one embodiment of this flavored taco shell, at least one of the elements will have a thickness of less than 1.5 millimeters. In other embodiments of this flavored taco shell, the curvilinear segments proximate the base can have large, medium or small radii.

In another embodiment, the cooled deep-fat fried flavored taco shell has a first sidewall element, a second sidewall element and a U-shaped base element. The U-shaped base element is characteristic of traditional U-shaped tacos. The U-shaped base element comprises a single curvilinear segment interconnecting the first and second sidewall elements. The cooled deep-fat fried U-shaped flavored taco shell has a minimum lip distance of 35 to 45 millimeters. In comparison, the lip distance of hot deep-fat fried U-shaped flavored taco shells is 45 to 55 millimeters. The lip distance of cooled deep-fat fried flavored “U” corn tortilla taco shells is 20% to 40% smaller than the lip distance of hot deep-fat fried flavored “U” corn tortilla taco shells.

The present invention, further resides in methods of making flavored masa dough. In one embodiment, the method entails mixing corn masa flour, water, seasoning blend, salt and optionally added fat, color and preservatives. In another embodiment the method entails grinding flavored or unflavored deep-fat fried corn tortillas, commonly referred to as rework or regrinds, and admixing to corn masa flour prior to blending with water, seasoning blend, salt, and optional ingredients.

The present invention, in several embodiments further resides in making flavored corn masa tortillas. In one embodiment, the method entails portioning corn masa dough into small segments, flattening small segments of flavored corn masa dough into round tortillas of a desired diameter and thickness, and cooking by applying heat to both sides until a desired moisture content and doneness is achieved.

The present invention, in several embodiments, further resides in methods of making a flavored corn masa taco shell intermediate. In one embodiment, the method entails providing a flavored soft flexible uncooked, partially cooked or fully cooked corn masa tortilla and placing the tortilla in or on a mold. The mold is configured so the resulting taco shell has a first sidewall and a second sidewall interconnected by a substantially flat base, a W-shaped base or a U-shaped base. The flavored taco intermediate is configured so the lip distance of the taco intermediate is approximately 25% to 30% larger than the desired lip distance of cooled deep-fried flavored taco shells. Additionally, flavored taco shell intermediates of flavored self-standing taco shells are configured with a lip distance 2.5 to 3 times the width of the base prior to deep-fat frying.

In one embodiment, the present methods of making a hot deep-fat fried, flavored corn tortilla taco shell involves providing a flavored corn masa taco shell intermediate. The flavored corn masa taco shell intermediate is deep-fat-fried in hot cooking oil until a desired temperature, shape, moisture, residual oil content and doneness are achieved. The hot deep-fat fried, flavored corn tortilla taco shell is prepared so the lip distance of the hot flavored taco shell is approximately 25% to 30% larger than the desired lip distance of cooled deep-fried flavored taco shells. Additionally, hot deep-fat fried flavored self standing corn taco shells are prepared with a lip distance 2.5 to 3 times the width of the base prior to cooling.

In one embodiment, the present methods of making a cooled deep-fat fried, flavored corn tortilla taco shell involves providing a hot deep-fat fried flavored corn tortilla taco shell. The hot deep-fat fried, flavored corn tortilla taco shell, hot from deep-fat frying, is removed from the fryer and placed on its side to cool until a desired temperature, shape, moisture and residual oil content is achieved. The cooled deep-fat fried, flavored corn tortilla taco shell is prepared so the lip distance of the cooled flavored taco shell is approximately 25% to 30% smaller than the lip distance of flavored taco shell intermediates and hot deep-fat fried flavored corn tortilla taco shells. Additionally, cooled deep-fat fried flavored self standing corn tortilla taco shells are prepared with a lip distance 1.8 to 2.2 times the width of the base.

In another embodiment, the present method of making a cooled deep-fat fried self-standing, flavored taco shell includes preparing a cooled deep-fat fried self-standing, flavored taco shell where the height of the taco shell is approximately 1.50 to 4.0 times the width of the base.

In another embodiment, the present method of making a cooled deep-fat fried flavored self-standing taco shell includes preparing a cooled deep-fat fried flavored self-standing taco shell that has a first sidewall and a second sidewall interconnected by a substantially flat base. Further, the cooled deep-fat fried flavored taco shell is prepared so that the height of the cooled deep-fat fried flavored taco shell is approximately about 50-110 millimeters and the width of the base is at least 10-15 millimeters. In another embodiment, the method of making a cooled deep-fat fried flavored self-standing taco shell includes preparing a cooled deep-fat fried flavored self-standing taco shell so that the width of the base is at least 19 millimeters. In yet another method embodiment, the width of the base is approximately 25 millimeters.

In another embodiment, the present method of making a cooled deep-fat fried flavored self-standing taco shell includes preparing a cooled deep-fat fried flavored self-standing taco shell that has a first sidewall element, a second sidewall element and a substantially flat base element. Further, the cooled deep-fat fried flavored taco shell is prepared so that the flat base element comprises a first curved segment interconnecting the first sidewall element to a flat base segment, and a second curved segment interconnecting the second sidewall element to the flat base segment. In one embodiment of the present method this flavored taco shell is prepared so that at least one of the elements has a thickness of at least 1.5 millimeters. In one embodiment of the present method this flavored taco shell is prepared so that at least one of the elements has a thickness of less than 1.5 millimeters. In other embodiments of the present method this flavored taco shell is prepared so that the curved segments have a large, medium or small radii.

In another embodiment, the present method of making a cooled deep-fat fried flavored self-standing taco shell includes preparing a cooled deep-fat fried flavored self-standing taco shell that has a first sidewall element, a second sidewall element and W-shaped base element. Further, the cooled deep-fat fried flavored taco shell is prepared so that the W-shaped base element comprises a first curvilinear segment interconnecting the first sidewall element to an inversed curvilinear segment, and a second curvilinear segment interconnecting the second sidewall element to the inversed curvilinear segment. In one embodiment of the present method this flavored taco shell is prepared so that at least one of the elements will have a thickness of at least 1.5 millimeters. In one embodiment of the present method this flavored taco shell is prepared so that at least one of the elements will have a thickness of less than 1.5 millimeters. In other embodiments of the present method this flavored taco shell is prepared so that the curvilinear segments have a large, medium or small radii.

In another embodiment, the present method of making a cooled deep-fat fried flavored taco shell includes preparing a cooled deep-fat fried flavored taco shell that has a first sidewall element, a second sidewall element and a U-shaped base element. Further, the cooled deep-fat fried flavored taco shell is prepared so that the U-shaped base element comprises a single curvilinear segment interconnecting the first and second sidewall elements. In one embodiment of the present method this cooled deep-fat fried U-shaped flavored taco shell has a minimum lip distance of 35 to 45 millimeters. In comparison, the lip distance of hot deep-fat fried U-shaped flavored taco shells is 45 to 55 millimeters.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an end elevation view of a flavored corn masa taco intermediate in a wide taco mold.

FIG. 2 is an end elevation view of a deep-fat fried flavored “flat” self standing corn masa tortilla taco shell resting on its side on a planar surface.

FIG. 3 is an end elevation view of a deep-fat fried flavored self standing corn masa tortilla taco shell having a “W” shaped base resting on its side on a planar surface.

FIG. 4 is an end elevation view of a deep-fat flavored “U” corn masa tortilla taco shell resting on its side on a planar surface.

FIG. 5 is a flow chart illustrating a method of manufacturing a flavored taco shell.

### DETAILED DESCRIPTION

In its product aspect one embodiment of the present invention is flavored corn masa dough. The flavored masa dough product comprises preferably about 47-57% corn masa flour by weight (dry basis), 39-49% moisture by weight, 1-5% seasoning blend by weight (dry basis), 1-5% salt by weight (dry basis) and less than 0.5% added fat by weight (dry basis). The masa dough product can also optionally contain 3-6% ground deep-fat fried flavored corn taco shells by weight (dry basis), commonly referred to as regrinds or rework. The masa dough product can also optionally contain 1-3% other grain ingredients by weight (dry basis) for example ground oat, wheat or barley. The masa dough product can also optionally contain minor amounts less than 0.5% preservatives by weight (dry basis) and 0.5% natural or artificial color by weight (dry basis).

Throughout the specification and claims, percentages are by weight and temperatures in degrees Celsius unless otherwise indicate. Each referenced patent or patent application is hereby incorporated by reference.

Masa means “dough” in Spanish, but in Mexico it is generally understood as corn dough. Masa is made by boiling corn kernels in powdered unslaked lime (calcium oxide), washing them and then grinding. Enough water is then mixed into the meal to make a thick paste or dough. Smoother, soft masa is required for tortillas, and coarser, stiff masa is used for tamales. “Masa harina” is factory-made, powdered masa, i.e., flour ground from corn kernels that have been soaked in slaked lime that is often sold in bulk. Masa harina can be used to make anything that calls for masa. Masa harina is thus to be distinguished from mere corn flour that has not been lime slaked and heated.

Any commercially available corn masa flour can be selected for use in flavored masa dough. For example, commercially available corn masa flour can be obtained from Cargill, Inc. located in Minnesota USA. Corn masa flour is commonly available in white and yellow varieties and is sold ground to fine, medium and course particulate sizes. Corn masa flour is also available in less common color varieties such as blue, black and red, one skilled in the art of product formulation would have little difficulty substituting a color variety to suit the end application. Yellow coarse masa flour is preferred for flavored taco shell applications. Otherwise, color and particulate size of corn masa flour can be subjectively selected by the product developer to match the desired application of the finished flavored corn masa product. Any product developer skilled in the art will have little difficulty selecting corn masa flour suitable to make flavored corn masa dough of the desired color and texture preferred.

While preferred for use herein are masa doughs comprising one or more corn (maize) flour ingredients (e.g., a mixture of white and yellow corn flours), the skilled artisan will appreciate that in less preferred embodiments, the masa dough can include minor amounts of one or more farinaceous ingredients such as flours from other non-maize cereal grains (major cereal grains such as barley, wheat, rice or oats), or their starch fractions.

Any potable water can be selected for use in flavored masa dough. Municipal drinking water of relatively neutral pH 6-8 is preferred because of cost and availability. Good results are obtained when the masa dough has a moisture content ranging from about 39-49%.

Seasoning blends suitable for flavoring corn masa dough are preferably dried and may or may not contain dairy ingredients. Dried ground garden vegetables herbs and spices and mixtures thereof are all suitable for creating a seasoning blend. Dried ground garden vegetables can include but is not limited to celery, carrot, tomato, onion, peppers (all varieties), beets, broccoli, spinach, and kale. Dried ground herbs and spices can include but is not limited to basil, rosemary, thyme, oregano, chives, garlic, peppercorns, cloves, cinnamon, paprika, cumin, anise, mustard and ginger. Dried seasonings may additionally contain minor amounts of preservatives, fillers and anti-caking or flowing agents to extend the shelf-life and ease of use of these ingredients. Seasoning blends may contain dairy ingredients and flavorings to impart dairy flavors in flavored masa dough such as nacho cheese. Dairy ingredients may include but are not limited to dried ground cheese, cheese powder, whey powder, dried milk powder and combinations thereof. Highly concentrated liquid seasoning or extracts may also be used, but are less preferred because of their cost and the adjustments required to the formula to account for the added moisture these ingredients provide.

Any commercially available food grade salt (sodium chloride) is suitable for use in flavored corn masa dough. Medium ground salt or finer is preferred to facilitate mixing and blending into flavored corn masa dough. Mixtures of sodium chloride and potassium chloride can also be used to provide reduced sodium content food products. It is important to have the salt incorporated into the corn masa dough in order to enhance the seasoning blend. While increased amounts of salt are desirable to boost the impact of the seasoning blend, increased amounts of salt exaggerate problems of increased plasticity of the dough. While flavored masa dough can be prepared with less salt that exhibit reduced plasticity and therefore less lip distance reduction, such products can be perceived by consumers as bland or deficient in flavor. Of course the flavor impact of flavored corn tortilla taco shells can be increased by increasing seasoning blend content level, however since such seasoning ingredients are ten times more expensive than corn masa flour such high levels greatly increase the total cost of finished products. For this reason it is important that salt is incorporated vs. topically applied.

Minor amounts of commercially available edible animal or vegetable fat may optionally be added to flavored corn masa dough. Added fat is to be distinguished from fat contributed by corn masa flour or cheese ingredients. A product developer skilled in the art may selectively add fat as a processing aid, component of a seasoning ingredient or component of a ground fried flavored taco shell rework or regrind ingredient. Good results can be obtained when the formulation fat ingredient is less than 0.5% of an edible fat or shortening ingredient. Also, while hydrogenated fats, especially derived from vegetable oils can be used, current consumer heath interest favor use of non-hydrogenated liquid oils especially vegetable oils rather than solid or semi-solid fats such as from hydrogenated fats to reduce the levels of undesirable trans fatty acids.

Flavored masa dough can optionally contain ground deep-fat fried flavored taco shells (e.g., rework or regrinds). Ground deep-fat fried flavored taco shells are made by grinding fried flavored taco shells into pieces 1-10 millimeters in diameter. Any product developer skilled in the art would have little difficulty selecting a food mill or blender capable of grinding deep-fat fried flavored taco shells to a reasonably uniform size to create this optional rework ingredient.

Flavored masa dough can also optionally contain other grain ingredients for example ground oat, wheat or barley. Such grain based flour materials are commonly available. A product developer skilled in the art may selectively add other ground grains to enhance the color, flavor or handling properties of flavored corn masa dough or one of its many end products depending on the application.

Flavored masa dough can also optionally contain minor amounts of preservatives. A product developer skilled in the art of food formulation will have little difficulty obtaining commercially available food grade preservatives. Any of the know antimicrobial or antioxidant food preservatives can be selectively used in flavored corn masa dough to extend product shelf-life. The products herein can additionally include common levels and types of anti-oxidants and preservatives such as vitamin E, BHA (Butylated hydroxyanisole), BHT (butylated hydroxytoluene), TBHQ (Tert-Butyl Hydroquinone), and mixtures thereof, up to levels permitted by current food laws.

Flavored masa dough can also optionally contain minor amounts of natural or artificial color. To enhance the color of flavored corn masa dough natural or artificial color can be selectively used. One such food color ingredient is annatto which can enhance the yellow color of the finished shells preferred for use herein are flavor and color additives intended to mimic the yellow color of traditional yellow corn. While in certain jurisdictions, certain synthetic yellow colorants are permitted, especially useful herein for such color additives are those natural yellow colorants such as turmeric, beta carotene, and/or annatto. Other color ingredients may be selected purely to enhance the flavor perception of flavored corn masa dough. For example, red color may be used to enhance the perception of tomato flavor. Some manufacturers may elect to rely solely on color to convey a perceived flavor.

Another product aspect of the present invention are flavored corn masa tortillas. Generally round in shape, flavored corn tortillas comprise flavored corn masa dough flattened to a thickness of at least 1.5 millimeters. Depending on the application for the finished flavored tortillas, flavored corn masa dough is flattened or cut to a diameter of 40-60 millimeters for tortilla chips, 60-80 millimeters for mini tacos, 120-180 millimeters for traditional tacos and 250-350 millimeters for burritos and wrap-style sandwiches. Preferred for use herein are tortillas ranging from about 120-180 millimeters in diameter and weighing about 10 to 30 grams each. In preferred variations, the tortillas each range from about 10-20 grams and for best results between 10-15 grams. Tortillas are cooked by applying heat to both sides or flash baking until a desired moisture content and doneness is achieved. Desired doneness can include partially to fully cooked tortillas. Selected applications may use uncooked tortillas. One skilled in the art of food processing will have little difficulty selecting a device for cooking tortilla shells. Commercial production of tortillas has made industrial sized tortilla formers and cookers widely available.

Another embodiment of flavored corn masa tortillas are partially cooked flavored corn masa tortillas. The partially cooked flavored corn masa tortilla article comprises on a dry basis preferably about 47-57% corn masa flour by weight (dry basis), 15-30% moisture by weight, 1-5% seasoning blend by weight (dry basis), 1-5% salt by weight (dry basis) and 0.1-1% added fat by weight (dry basis). Flavored corn masa tortillas can also optionally contain minor amounts of rework or regrinds 3-6% by weight (dry basis), other grain ingredients 1-3% by weight (dry basis), preservatives less than 0.5% by weight (dry basis) and natural or artificial color 0.5% by weight (dry basis). While describing the composition of the partially cooked flavored corn masa tortilla article on a dry basis demonstrates the consistent, range of ingredients from flavored corn masa dough to flavored corn masa tortilla to flavored corn masa taco intermediate to flavored corn tortilla taco, it is common to also describe similar compositions on a wet basis. The partially cooked flavored corn masa tortilla article comprises on a wet basis preferably 65-72% corn masa flour by weight, 15 to 30% water by weight, 2-6% seasoning blend by weight, 2-5% salt by weight and 0.1 to 1% added fat by weight. Flavored corn masa tortillas can also optionally contain on a wet basis minor amounts of rework or regrinds 4-7% by weight, other grain ingredients 2-4% by weight, preservatives less than 1% by weight and natural or artificial color 1% by weight.

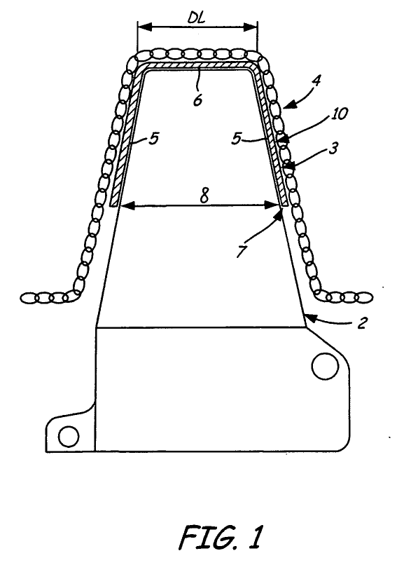

Another product aspect of the present invention is a flavored corn masa taco shell intermediate. Referring now to FIG. 1, there is seen an end elevation view of a flavored taco shell intermediate 10 on a wide taco mold 2. The flavored corn masa taco shell intermediate 10 starts as a circular flavored corn masa tortilla 3 shaped by the wide taco mold 2. A chain mesh cover 4 holds the corn masa tortilla 3 on the wide taco mold 2. The wide taco mold 2 imparts a desired “flat” self standing taco shape to the flavored corn masa tortilla 3 forming the flavored taco shell intermediate 10. The flavored corn masa taco shell intermediate 10 has a pair of opposed sidewalls 5 that are interconnected by a flat base 6. Flavored corn masa taco shell intermediates 10 have a base width (represented by the letters “Db”) of about 25±10 millimeters (15-35 millimeters). The pair of opposed sidewalls 5 have a top edge 7. The top edge 7 of each sidewall 5 is free of connection to the opposed sidewall 5. Flavored taco shell intermediates 10 have a lip distance 8 defined as the total distance between the top edge 7 of the opposed sidewalls 5 of about 65 to 75 millimeters that is 2.5 to 3 times the base width Db of about 25 millimeters. In comparison, the lip distance 8 of flavored taco shell intermediates 10 is 25% to 30% larger than the lip distance of cooled deep-fat fried flavored taco shells.

In still another product aspect the present invention is a deep-fat fried flavored corn tortilla taco shell fabricated from a deep-fat fried flavored corn masa taco intermediate. Deep-fat fried flavored corn tortilla taco shells in addition to the deep-fat fried flavored corn masa taco intermediate contain 5-35%, preferably 25% or less absorbed cooking or frying oil and 8% or less residual moisture. Cooking oil or frying oil may include any commercially available animal or vegetable oils. Animal and vegetable cooking oils or frying oils can be used interchangeable and include but are not limited to beef tallow or pork lard, corn oil, soybean oil, canola oil, peanut oil or combinations thereof. Cooking or frying oils may be partially or fully hydrogenated and contain preservatives to extend shelf-life. Soybean oil is preferred because of its neutral flavor, cost and availability.

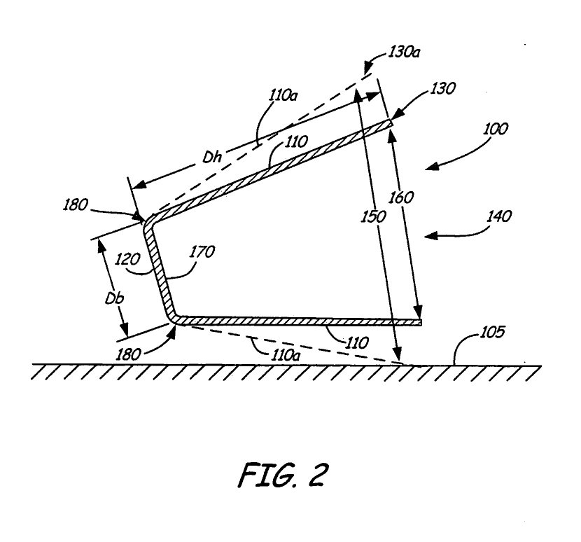

In a preferred embodiment, deep-fat fried flavored taco shells are stable and self standing. FIG. 2 is an end elevation view of a flavored “flat” self-standing taco shell 100 formed from a circular tortilla. The flavored finished self-standing taco shell 100 is depicted on its side resting on a flat surface 105. The flavored self-standing taco shell 100 has a pair of opposed sidewalls 110 that are interconnected by a flat base 120. The pair of opposed sidewalls 110 have a top edge 130. The top edge 130 of each sidewall 110 is free of connection to the opposing sidewall 110, creating the open end 140 of the shell 100.

The flavored self-standing taco shell 100 is hot (about 150 to 1800° C.) immediately after deep-fat frying. When the flavored free standing taco shell 100 is hot it is in a soft plastic state. Still referring to FIG. 2, when the flavored free standing taco shells 100 are hot they have an initial lip distance 150 defined as the total distance between the top edge 130 in an initial position 130a of the opposed sidewalls 110 in a initial position 110a. The initial lip distance 150 of hot flavored self-standing taco shells 100 is relatively large approximately 60 millimeters, however gravity immediately causes the opposed sidewalls 110 in their initial position 110a to converge compressing or reducing the initial lip distance 150 to a final lip distance 160 as the hot flavored self-standing taco shell 100 cools. As flavored self-standing taco shells 100 cool from a hot temperature range of about 150 to 180° C. to temperatures below about 140° C. their soft plastic state transforms to a solid crispy more frangible state. In this solid more frangible state the final lip distance 160 is set. Flavored flat bottom taco shells also have a cooled lip distance 160 defined as the total distance between the top edge 130 of the opposed sidewalls 110 after cooling. The preferred minimal lip distance 160 for flavored self-standing taco shells 100 is about 55 millimeters.

Still referring to FIG. 2, in another embodiment deep-fat fried self-standing flavored taco shells 100 upon removal from the deep fat fryer are hot about 150 to 180° C. The initial lip distance 150 of hot deep-fat fried flavored taco shells 100 is larger than the final lip distance 160 of cool deep-fat fried flavored taco shells 100 for example, about 25% to 35% larger.

Still referring to FIG. 2, deep-fat fried self-standing flavored taco shells 100 have a base width (represented by the letters “Db”) of about 25 millimeters. In another embodiment deep-fat fried flavored taco shells 100 upon removal from the deep fat fryer are hot about 150 to 180° C. The initial lip distance 150 of hot deep-fat fried flavored taco shells 100 can be 2.5 to 3 times the base width Db. The final lip distance 160 of cool deep-fat fried flavored taco shells 100 is 1.8 to 2.2 times the base width Db.

Still referring to FIG. 2, deep-fat fried self-standing flavored taco shells 100 have a shell height (represented by the letters “Dh”) preferably of about 50 to 110 millimeters. In another embodiment deep-fat fried flavored taco shells 100 have a shell height Dh 1.50 to 4.0 times the base width Db. One skilled in the art can appreciate that a food trough can be created with a Dh of about 12 to 50 millimeters as described in patent application PCT/US02/36474 Square Bottom Taco Shell, Kovich et al.

Still referring to FIG. 2, the flat base 120, of the self standing flavored taco shell 100, comprises a flat segment 170, that is bordered by two curved segments 180. Each curved segment 180 serves as a transition from the flat base 120 to the sidewalls 110. In one embodiment of the invention, as described in patent application PCT/US02/36474 Square Bottom Taco Shell, (equivalently, US 2006/0147587 published Jul. 6, 2006) by Kovich et al., the radii of the curved segments 180 are large (approximately 6 millimeters or greater), forming rounded transitions from the flat base 120 to the sidewalls 110. In another embodiment of the invention, the radii of the curved segments 180 are medium (approximately 6 millimeters to 3 millimeters). In still another, embodiment of the invention, the radii of the curved segments are small (approximately 3 millimeters or less), forming transitions from the flat base 120 to the sidewalls 110 that have a profile with a very pronounced edge.

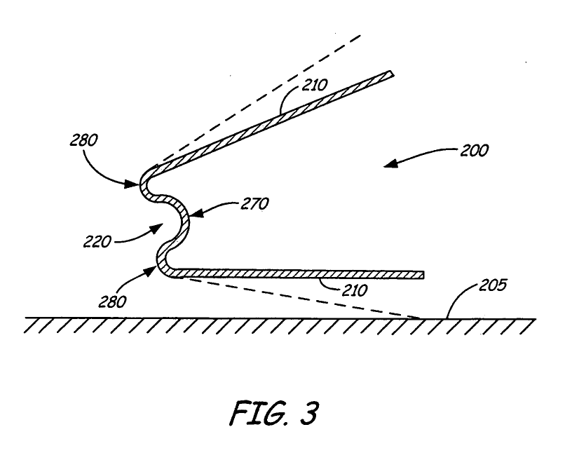

FIG. 3 is an end elevation view of a deep-fat fried flavored “W” self standing taco shell 200 formed from a circular flavored tortilla (reminiscent of those shells as described in greater detail in U.S. Pat. No. 5,993,871 “Stable, Self-Supported Taco Shell”). The deep-fat fried flavored “W” self standing taco shell 200 is depicted on resting on its side on a planar surface 205. The deep-fat fried flavored “W” self standing taco shell 200 has a pair of opposed sidewalls 210 that are interconnected by a W-shaped base 220. The W-shaped base 220 has a pair of opposed curvilinear segments 280. The opposed curvilinear segments 280 interconnect the sidewall 210 to an inversed curvilinear segment 270. The convergence of the opposed side walls of hot deep-fat fried flavored “W” self standing corn tortilla taco shells mirrors that of deep-fat fried flavored “flat” self standing corn tortilla taco shells.

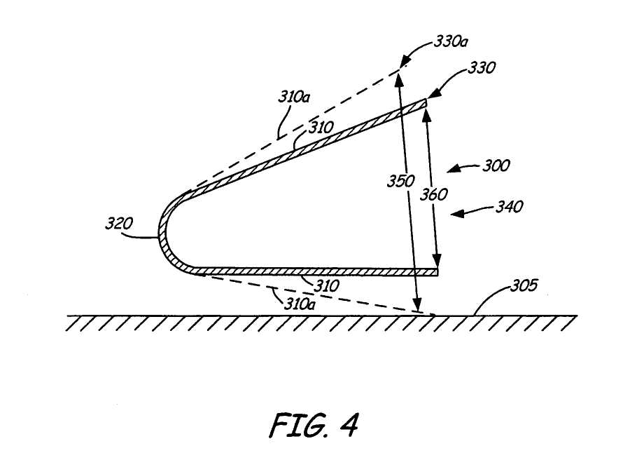

FIG. 4 is an end elevation view of a deep-fat fried flavored “U” corn tortilla taco shell 300 formed from a circular flavored tortilla. The deep-fat fried flavored “U” corn tortilla taco shell 300 is depicted resting on its side on a planar surface 305. The deep-fat fried flavored “U” corn tortilla taco shell has a pair of opposed walls 310 that are interconnected by a U-shaped base 320. The pair of opposed walls 310 have a top edge 330. The top edge 330 of each sidewall 310 is free of connection to the opposing sidewall 310, creating an open end 340 of the deep-fat fried flavored “U” corn tortilla taco shell 300. The deep-fat fried flavored “U” corn tortilla taco shell 300 is hot (about 150 to 180° C.) immediately after deep-fat trying. When the deep-fat fried flavored “U” shaped corn tortilla taco shell 300 is hot it is in a soft plastic state. When the deep-fat fried flavored “U” shaped corn tortilla taco shells 300 are hot they have an initial lip distance 350 defined as the total distance between the top edge 330 in an initial position 330a of the opposed sidewalls 310 in an initial position 310a. The initial lip distance 350 of hot deep-fat fried flavored “U” corn tortilla taco shells 300 is relatively large approximately 45 to 55 millimeters, however gravity immediately causes the opposed sidewalls 310 in their initial position 310a to converge compressing the initial lip distance 350 to a final lip distance 360 as the hot deep-fat fried flavored “U” corn tortilla taco shell 300 cools. The final lip distance 360 of cooled deep-fat fried flavored “U” corn tortilla taco shells 300 is approximately about 35 to 45 millimeters. As deep-fat fried flavored “U” corn tortilla taco shells 300 cool from a hot temperature range of about 150 to 180° C. to temperatures below about 140° C. their soft plastic state transforms to a solid more frangible state.

Still referring to FIG. 4, in another embodiment deep-fat fried flavored “U” corn tortilla taco shells 300 upon removal from the deep fat fryer are hot about 150 to 180° C. The initial lip distance 350 of hot deep-fat fried flavored “U” corn tortilla taco shells 300 is 20% to 40% larger than the final lip distance 360 of cool deep-fat fried flavored “U” corn tortilla taco shells 300.

Another embodiment of the present invention is deep-fat fried flavored corn tortilla taco shells. The deep-fat fried flavored corn tortilla taco shell article comprises on a dry basis preferably about 47-57% corn masa flour by weight (dry basis), 15-30% absorbed cooking or frying oil by weight (dry basis), 2-8% moisture by weight, 1-5% seasoning blend by weight (dry basis), 1-5% salt by weight (dry basis) and 0.1-1% added fat by weight (dry basis). The deep-fat fried flavored corn tortilla taco shell article can also optionally contain minor amounts of rework or regrinds 3-6% by weight (dry basis), other grain ingredients 1-3% by weight (dry basis), preservatives less than 0.5% by weight (dry basis) and natural or artificial color 0.5% by weight (dry basis). While describing the composition of the deep-fat fried corn tortilla taco shell article on a dry basis also demonstrates the consistent, range of ingredients from flavored corn masa dough to flavored corn masa tortilla to flavored corn masa taco intermediate to flavored corn tortilla taco, it is common to also describe similar compositions on a wet basis. The deep-fat fried corn tortilla taco shell article comprises on a wet basis preferably 70-78% corn masa flour by weight, 15-30% absorbed cooking or frying oil by weight, 2 to 8% water by weight, 2-6% seasoning blend by weight, 2-5% salt by weight and 0.1 to 1% added fat by weight. The deep-fat fried flavored corn tortilla taco shell article can also optionally contain on a wet basis minor amounts of rework or regrinds 4-7% by weight, other grain ingredients 2-4% by weight, preservatives less than 1% by weight and natural or artificial color 1% by weight.

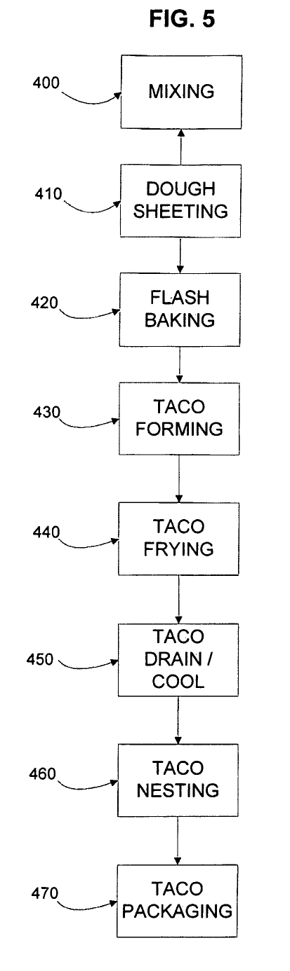

A process of making the self-standing taco shell 100 will now be described by referring to the process flow chart illustrated in FIG. 5. Initially, a flavored masa dough is formed. As one of ordinary skill in the art would recognize, this can be done by purchasing masa dough from a vendor and subsequently flavoring it, purchasing masa flour and mixing it with water, seasoning blend, salt, annatto (an optional yellow coloring) and optionally rework to form flavored masa dough (block 400), or by purchasing raw corn and processing it to make flavored masa dough. If raw corn is purchased, the raw corn is cooked with lime and then steeped. The corn is then washed and ground into masa paste, which is then mixed with other ingredients to form the flavored dough.

The present methods of preparation can additionally include a dough sheeting step to form the masa dough into suitably shaped and sized individual pieces such as tortillas. The dough sheeting steps can be practiced by dough entering the sheeting machine, which forms raw flavored masa tortillas (block 410). In one embodiment of the invention, the flavored tortillas will have a thickness of less than 1.5 millimeters. In another embodiment of the invention, the flavored tortillas will have a thickness of approximately 1.5 to 3.0 millimeters or greater. Also, while the present invention finds particular suitability for use in connection with the provision of corn or maize based masa flour, the skilled artisan will appreciate that the present invention finds usefulness in provision of other grains such as wheat for wheat/corn blends based formed flavored taco shells.

The present methods can additionally comprise a step of flash baking. The raw flavored masa tortillas can optionally then be flash baked, resulting in raw flavored masa tortillas with toast marks (block 420) as well as a reduced moisture content so as to thereby minimize fat take-up during the subsequent frying step. The toasted still soft and flexible flavored tortillas are then formed into self-standing flavored taco shell intermediated having substantially flat bases (block 430).

During the forming process, the tortillas are placed on molds and the tortillas conform to the molds (block 430). The molds can be a wire mesh mold, a wire cage mold, a combination wire mesh/cage mold, or a conventional mold having upper and lower plates. In either case, the molds are flat-bottomed and have cross-sectional elevations like the self-standing taco shells 100 shown in FIG. 2, or are “W” bottomed and have cross-sectional elevations like the “W” taco shells 200 shown in FIG. 3, or are “U” bottomed and have cross-sectional elevations like the “U” taco shells 300 shown in FIG. 4 and as discussed above. Like the self standing taco shells 100 illustrated in FIG. 2, the curved segments of the mold may have large, medium or small radii as discussed above.

Still referring to block 430, in the production of self standing flavored “flat” taco shells 100 shown in FIG. 2, the molds are designed to create the flavored taco intermediate 10 shown in FIG. 1, with a lip distance 8 that is 25% to 30% larger than the cooled deep-fried flavored “flat” corn tortilla taco shell 100. Likewise, in the production of self standing flavored “W” taco shells 200 shown in FIG. 3, the molds have a lip distance that is 25% to 30% larger than the cooled deep-fried flavored shell. Similarly, in the production of “U” taco shells 300 shown in FIG. 4, the molds have a lip distance that is 20% to 40% larger than the cooled deep-fried flavored shell.

The conformed flavored taco shell intermediates are then fried and adopt the form of the molds (block 440). The flavored taco intermediates exit the fryer on their sides as fried flavored self-standing “flat” taco shells, fried flavored self-standing “W” taco shells or traditional “U” taco shells at a temperature of 150 to 180° C. and a moisture content of less than about 8%. Since the formed flavored tacos are still plastic or pliable while still hot immediately after frying, placing the shells on their sides allows gravity to act upon the shells causing a convergence of the opposed sidewalls. The taco intermediates and hot taco shells are purposely designed to be 25% larger than the cooled deep-fat fried shells to take advantage of this convergence.

Oil drains from the flavored taco shells as the opposed sidewalls converge until cooled sufficiently (block 450) to harden. In another embodiment, the flavored tortillas are baked to a final moisture content of less than 8% to form low fat shaped rigid flavored tacos. A number (e.g., 3-6) of the cooled hardened rigid flavored taco shells are then nested (block 460) together into nested quantities and these nested quantities preferably provided with an intermediate spacer (not shown) and packaged (block 470) such as by providing one or more of the nested quantities onto a support board and then a film over wrap.

Minimizing the formation of discontinuities (e.g., bubbles and voids) in a flavored taco shell can be a challenge when commercially producing flavored taco shells. Discontinuities in flavored taco shells can be minimized by providing masa flour of the proper granulation, properly blending the dry ingredients, using the proper ratios of ingredients, maintaining the proper moisture level in the flavored dough, baking and frying properly, and avoiding the use of taco shell molds having complex geometries. Because the flat-bottomed molds have simple geometric characteristics, the tortillas readily conform to the molds, minimizing the potential for the formation of destabilizing discontinuities, especially those at the base 120 of the shell 100 shown in FIG. 2.

It will be appreciated that by maintaining the lip distance sufficiently to provide an open finished taco shell, a number of individual taco shells can be nested together (e.g., 3-6) to provide a nested array of square bottomed taco shells. Such an open configuration allows for minimizing breakage of the fragile finished shells during packaging including forming a nested array of such shells. Importantly, by providing such an open configuration, mechanical nesting apparatus can be employed to provide such a nested shell array (See, for example, US 2005/0050858 “Taco Shell Nesting Apparatus and methods” published Mar. 3, 2005 by Cremers et al.) instead of time consuming and costly hand assembly.

A quantity (e.g., 3-6) of such flavored square bottomed taco shells of the present invention can be provided in the form of a nested array (not shown) and provided in a suitable consumer food packaging such as being mounted upon a paperboard support such as U-board and over wrapped with a flexible packaging film (e.g. A clear shrink-wrap packaging film). If desired, a spacer insert can be provided between the sides of the top nested shell to provide additional protection against breakage such as by unintended compression of the packaged food article. In preferred articles, the wrapped nested array of taco shells is disposed within an outer protective carton.

While the present flavored taco shells can be provided with an additional or supplemental topical flavoring feature, in the preferred embodiment the flavored taco shells are free of any such additional or supplemental seasoning or flavoring. Such shells free of any surface or topical supplemental seasoning provide additional consumer consumption convenience by reducing the tendency of any such topical seasoning to undesirably transfer to the consumer's finger during handling whether during preparation or consumption.

Although the present invention has been described with reference to preferred embodiments, persons skilled in the art will recognize that changes may be made in form and detail without departing from the spirit and scope of the invention.

We claim:

1. A flavored corn masa dough composition, comprising:
about 47-57% corn masa flour by weight (dry basis);
about 39-49% by weight moisture;
1-5% seasoning blend by weight (dry basis); and
1-5% salt by weight (dry basis).

2. The flavored corn masa dough of claim 1 wherein the corn masa flour is yellow coarse ground masa flour.

3. The flavored corn masa dough of claim 1 wherein the seasoning blend contains dairy ingredients.

4. The flavored corn masa dough of claim 1 additionally comprising less than 1% added fat.

5. The flavored corn masa dough of claim 1 additionally comprising less than 1% preservatives.

6. The flavored corn masa dough of claim 1 additionally comprising less than 1% food color.

7. The flavored corn masa dough of claim 1 additionally comprising 0.1% up to about 4% or less ground deep-fat fried flavored taco shells.

8. A flavored cooked corn masa tortilla article fabricated from corn masa dough comprising:
about 47-57% corn masa flour by weight (dry basis);
about 15-30% by weight moisture;
1-5% seasoning blend by weight (dry basis);
1-5% salt by weight (dry basis); and
0.1-1% added fat by weight (dry basis).

9. A flavored corn masa taco intermediate article, comprising:
A molded flavored corn masa tortilla having a first sidewall and a second sidewall interconnected by a substantially flat base, the flavored corn masa tortilla configured with a lip distance is 2.5 to 3 times the width of the base.

10. The flavored corn masa taco intermediate article of claim 9 wherein the lip distance is 65 to 75 millimeters.

11. The flavored corn masa taco intermediate article of claim 9 mounted upon a mold.

12. The flavored corn masa taco intermediate of claim 9 in the form of a hot deep-fat fried corn tortilla taco shell with a flexible or plastic body.

13. A deep-fat fried flavored corn tortilla taco shell article fabricated from a corn masa dough, comprising:
about 47-57% corn masa flour by weight (dry basis);
about 2-8% by weight moisture;
1-5% seasoning blend by weight (dry basis);
1-5% salt by weight (dry basis); and
having 15-30% absorbed cooking oil by weight (dry basis).

14. The deep-fat fried flavored corn tortilla taco shell of claim 13 wherein at least a portion of the salt is topically applied.

15. The deep-fat fried flavored corn tortilla taco shell of claim 13 wherein at least a portion of the seasoning blend is topically applied.

16. The deep-fat fried flavored corn tortilla taco of claim 13 substantially free of topically applied salt and seasoning blend.

17. A flavored self-standing, flavored corn masa tortilla taco shell article being dimensionally stable at room temperature, comprising:
about 47-57% corn masa flour by weight (dry basis);
about 2-8% by weight moisture;
1-5% seasoning blend by weight (dry basis);
1-5% salt by weight (dry basis);
having 15-30% absorbed cooking oil by weight (dry basis); and
a. a first sidewall and a second sidewall interconnected by a substantially flat base, the flavored taco shell configured so the height of the taco shell is approximately 1.50 to 4.0 times the width of the base.

18. The flavored taco shell of claim 17 wherein the base is “W” shaped.

19. The flavored taco shell of claim 17 wherein the height of the flavored taco shell is about 2.0 to 3.0 times the width of the base.

20. The flavored taco shell of claim 17 wherein the height of the flavored taco shell is about 2.0 to 2.5 times the width of the base.

21. A flavored stable, self-standing, taco shell, comprising:
a. a first sidewall and a second sidewall interconnected by a substantially flat base, the flavored taco shell configured so the lip distance of the flavored taco shell is about 40 to 60 millimeters and the width of the base is at least about 18 millimeters.

22. The flavored taco shell of claim 21 wherein the base is “W” shaped.

23. The flavored taco shell of claim 21 wherein the base width of the flavored taco shell is about 20 millimeters or greater.

24. The flavored taco shell of claim 21 wherein the base width of the flavored taco shell is about 22 millimeters or greater.

25. The flavored taco shell of claim 21 wherein the base width of the flavored taco shell is about 25 to 26 millimeters.

26. The flavored taco shell of claim 21 wherein the lip distance of the flavored taco shell is about 45 to 55 millimeters and the base width of the flavored taco shell is at least about 20 millimeters or greater.

27. The flavored taco shell of claim 21 wherein the lip distance of the flavored taco shell is about 45 to 55 millimeters and the base width of the flavored taco shell is about 22 millimeters or greater.

28. The flavored taco shell of claim 21 wherein the lip distance of the flavored taco shell is about 45 to 55 millimeters and the base width of the flavored taco shell is about 25 to 26 millimeters.

29. The flavored taco shell of claim 21 wherein the lip distance of the flavored taco shell is about 50 to 55 millimeters and the base width of the flavored taco shell is about 22 millimeters or greater.

30. A method of making a flavored stable, self-standing, taco shell, comprising:
providing a flavored tortilla; and
placing the flavored tortilla on a mold configured so the resulting flavored taco shell has a first sidewall and a second sidewall interconnected by a substantially flat base, and the height of the resulting flavored taco shell is about 1.50 to 4.0 times the base width of the flavored taco shell.

31. The method of claim 30 wherein the height of the resulting flavored taco shell is about 1.75 to 3.35 times the width of the base.

32. The method of claim 30 wherein the height of the resulting flavored taco shell is about 2.0 to 3.0 times the width of the base.

33. The method of claim 30 wherein the height of the resulting flavored taco shell is about 2.0 to 2.5 times the width of the base.

34. A flavored stable, self-standing, taco shell, comprising:
a. a first sidewall element;
b. a second sidewall element;
c. a substantially flat base element;
d. a first curved element interconnecting the first sidewall element to the flat base element; and
e. a second curved element interconnecting the second sidewall element to the flat base element.

35. The flavored taco shell of claim 34 wherein at least one the elements has a thickness of less than 1.5 millimeters.

36. The flavored taco shell of claim 34 wherein at least one the elements has a thickness of at least 1.5 millimeters.

37. The flavored taco shell of claim 34 wherein at least one of the curved elements has a radius of about 6 millimeters or greater.

38. The flavored taco shell of claim 34 wherein at least one of the curved elements has a radius of about 3 to 6 millimeters.

39. The flavored taco shell of claim 34 wherein at least one of the curved elements has a radius of about 3 millimeters or less.

40. A method of making a flavored stable, self-standing, taco shell, comprising:
providing a flavored tortilla; and
a. placing the flavored tortilla on a mold configured so the resulting flavored taco shell has a first sidewall element, a second sidewall element, a substantially flat base element, a first curved element interconnecting the first sidewall element to the flat base element, and a second curved element interconnecting the second sidewall element to the flat base element.

41. The flavored taco shell of claim 40 wherein at least one the elements has a thickness of less than 1.5 millimeters.

42. The flavored taco shell of claim 40 wherein at least one the elements has a thickness of at least 1.5 millimeters.

43. The method of claim 40 wherein at least one of the curved elements has a radius of about 6 millimeters or greater.

44. The method of claim 40 wherein at least one of the curved elements has a radius of about 3 to 6 millimeters.

45. The method of claim 40 wherein at least one of the curved elements has a radius of about 3 millimeters or less.

46. A method of making a deep-fat fried flavored self-standing, taco shell, comprising the step of:
providing a flavored tortilla;
a. placing the flavored tortilla on a mold configured so the resulting flavored taco shell has a first sidewall element, a second sidewall element, a substantially flat base element, a first curved element interconnecting the first sidewall element to the flat base element, and a second curved element interconnecting the second sidewall element to the flat base element;
b. deep-fat frying the molded flavored tortilla shell in 165° C. cooking oil for 30 to 40 seconds;
c. removing the deep-fat fried flavored self-standing taco shell from the cooking oil; and,
d. subsequently the mold; and,
e. resting the deep-fat fried flavored self-standing taco shell on its side to cool to room temperature and harden to form a finished crispy shell.

47. A tortilla fabricated from the flavored masa dough of claim 2.

48. The article of claim 17 in a plurality of pieces in a nested array.
